(19) United States
(12) Patent Application Publication
(10) Pub. No.: US 2018/0345865 A1
(43) Pub. Date: Dec. 6, 2018

(54) ELECTRONIC SYSTEMS CENTER FOR A MOTOR VEHICLE

(71) Applicant: FORD GLOBAL TECHNOLOGIES, LLC, Dearborn, MI (US)

(72) Inventor: Kurt Hugh Maxwell, Canton, MI (US)

(21) Appl. No.: 15/609,627

(22) Filed: May 31, 2017

(51) Int. Cl. B60R 1/12; B60R 1/04; B60S 1/02; B60L 1/00

(52) U.S. Cl. CPC B60R 1/12; B60R 1/04; B60J 1/20; B60L 1/006; B60S 1/026

(57) ABSTRACT

An electronic systems center includes a housing, having a base and a cover, an image processing module held in the housing and an imaging port in the housing where that imaging port includes an integral glare shield. The electronic systems center may also include one or more of a USB charger, an EWAFS module, a rain sensor, a rearview mirror, a rearview mirror tether and windshield heater terminals.

### TECHNICAL FIELD

This document relates generally to the motor vehicle equipment field and, more particularly, to an electronic systems center for various sensor modules and other safety and convenience equipment for the motor vehicle.

### BACKGROUND

This document relates to a new and improved electronic systems center that houses a number of different electronic components and safety features along the upper center portion of the windshield of a motor vehicle. Advantageously, the electronic systems center has a low profile housing of compact design that minimizes forward vision obstruction. The electronic systems center may house some or all of the following: (1) an image processing module, also known as image processing module A (IPMA), comprising a camera that provides autonomous emergency braking, lane keep assistance and auto high beam control, (2) a rain light sensor (RLS) which functions as a rain sensor for automatic wiping and as an outdoor light sensor, (3) a USB charger such as a smart charger made for dash cam cameras and other dashboard mounted electronic equipment, (4) an electronic windshield anti-fogging system (EWAFS) comprising a temperature and humidity sensor that provides automatic operation of the defroster when conditions cause fogging of the interior windshield, (5) wire routing features that serve to eliminate rattling of wires within the housing, (6) a tethering hook to ensure safety in the event of interior rearview mirror detachment during a dynamic event, (7) clearances for heater terminals that attach wiring to a local heating grid adapted to maintain the windshield clear for proper operation of the IPMA and (8) cover mounting features that positively retain the housing cover while still providing ready access for service.

### SUMMARY

In accordance with the purposes and benefits described herein, an electronic systems center is provided. That electronic systems center comprises a housing including a base and a cover, an image processing module held in the housing and an imaging port in the housing, that imaging port including a glare shield. The imaging port may include diverging sidewalls for enhanced wide angle viewing.

The electronic systems center may further include a USB charger held in the housing. The electronic systems center may further include a rearview mirror tether. The electronic systems center may further include an EWAFS module held in the housing. The electronic systems center may further include a rain sensor held in the housing.

The electronic systems center may further include a rearview mirror carried on the housing. The electronic systems center may further include windshield heating grid or heater terminals carried on the housing.

The housing of the electronic systems center may further include a base and a low profile and cosmetic cover for concealing the electronic components and other features provided in the housing of the electronics systems center. That base may include an integral retainer holding the image processing module. The base may also include integral retainers for holding other components held in the electronic systems center.

In one or more of the many possible embodiments of the electronic systems center, the electronic systems center includes at least one device selected from a group consisting of a USB charger, an EWAFS module, a rain sensor, a rearview mirror, a rearview mirror tether, windshield heater terminals and combinations thereof carried on the housing. In addition, the electronic systems center may further include a fastener securing the housing to a motor vehicle windshield. That fastener may comprise any appropriate fastening device including, but not necessarily limited to, an appropriate adhesive.

In accordance with an additional aspect, an electronic systems center is provided comprising a housing including a base and a cover, a USB charger held in the housing and a fastener securing the housing to a windshield of a motor vehicle.

That electronic systems center may further include a rearview mirror tether. Further, that electronic systems center may further include a rearview mirror carried on the housing.

In addition, the electronic systems center may further include an EWAFS module carried in the housing. Further, the electronic systems center may include a rain sensor carried in the housing.

In accordance with yet another aspect, an electronic systems center comprises a housing, at least one device carried in the housing selected from a group consisting of an image processing module, a USB charger, an EWAFS module, a rain sensor, windshield heater terminals and combinations thereof and a rearview mirror tether carried on the housing. That rearview mirror tether may include a hook fixed to the housing. The hook may engage a line connected to the rearview mirror. In addition the electronics system center may further include a rearview mirror carried on the housing.

In the following description, there are shown and described several preferred embodiments of the electronic systems center. As it should be realized, the electronic systems center is capable of other, different embodiments and its several details are capable of modification in various, obvious aspects all without departing from the electronic systems center as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the electronic systems center and together with the description serve to explain certain principles thereof. In the drawing figures:

FIG. 1 is a perspective view looking upward toward the housing of the new and improved electronic systems center provided at the top center of the windshield adjacent the interior rearview mirror.

FIG. 2 is a detailed bottom plan view illustrating the various components mounted to the base of the housing of the electronic systems center (cover removed).

FIG. 3 is a view similar to FIG. 2 but of an alternative embodiment of the electronic systems center.

FIG. 4 is a detailed top plan view of the alternative embodiment of the electronic systems center illustrated in FIG. 3, showing the heating grid on the windshield and the imaging port in the base for the image processing module.

FIG. 5 is a more detailed view of FIG. 4 showing the glare shield provided on the imaging port.

FIG. 6 is a perspective view of the windshield engaging surface of the base of the electronic systems center housing illustrating the imaging port and the adhesive fastener utilized to secure the base to the windshield.

FIG. 7 is a detailed view of the rearview mirror tether used to retain the interior rearview mirror in the event of a dynamic event causing detachment of the mirror from the rearview mirror mount.

Reference will now be made in detail to the present preferred embodiments of the electronic systems center, examples of which are illustrated in the accompanying drawing figures.

### DETAILED DESCRIPTION

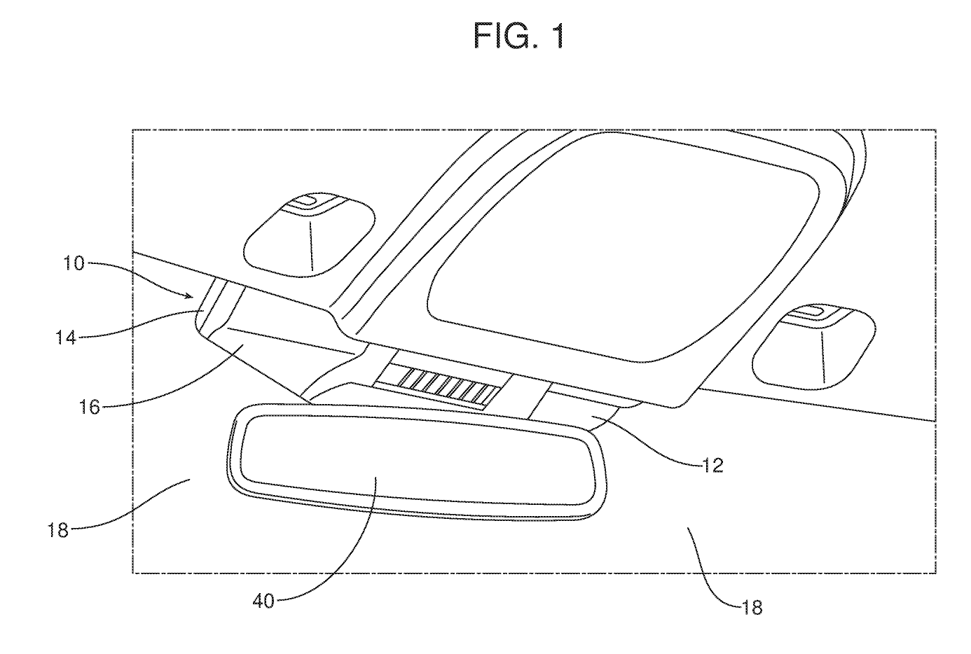

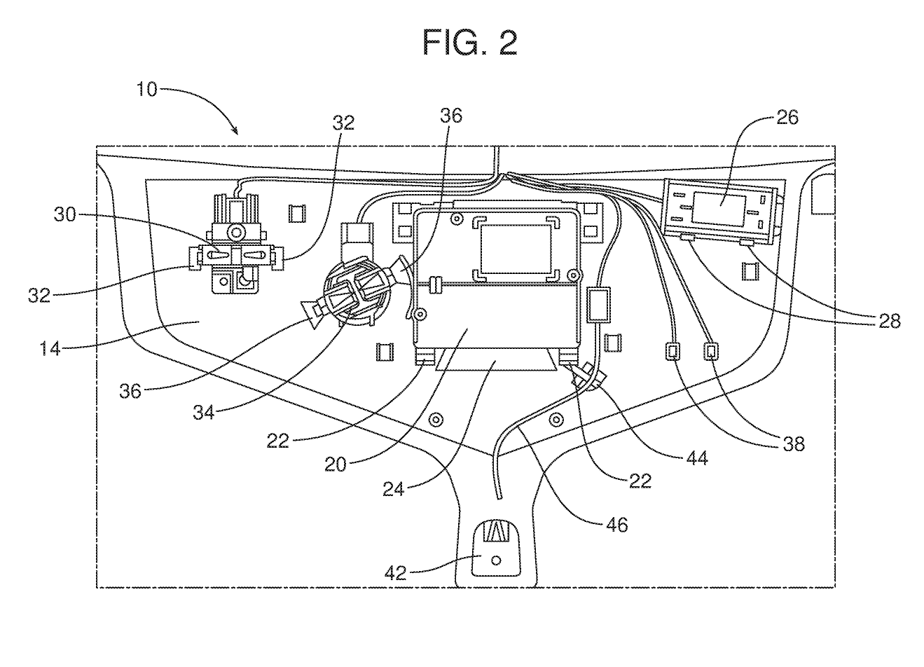

Reference is now made to FIGS. 1 and 2 illustrating a first possible embodiment of electronic systems center 10. That electronic systems center 10 includes a housing 12 having a bracket or base 14 closed by a cosmetic cover 16. In the illustrated embodiment the base 14 is mounted to the top center portion of the windshield 18 by adhesive or other appropriate means. As will be described in greater detail below various electronic system components and other features are carried in the housing 12 and concealed by the cover 16 that is attached to the base 14.

In the embodiments illustrated in FIGS. 1 and 2, the electronic systems center 10 includes an image processing module 20 such as an IPMA that provides data for autonomous emergency braking, lane keep assistance and auto high beam control. In the illustrated embodiment, the image processing module 20 is secured to the base 14 by means of an integral retainer 22 securely holding the image processing module 20 in position aligned with an imaging port 24.

The electronic systems center 10 illustrated in FIGS. 1 and 2 also includes a USB charger 26 secured to the base 14 by means of the integral retainer 28.

The electronic systems center 10 illustrated in FIGS. 1 and 2 also includes an EWAFS module 30 secured to the base 14 by means of the integral retainer 32. The EWAFS module 30 may comprise a temperature and humidity sensor that provides data for automatic operation of the defroster when conditions cause fogging of the interior surface of the windshield 18.

The electronic systems center 10 illustrated in FIGS. 1 and 2 also includes a rain sensor 34 secured by the integral retainer 36 to the base 14. The rain sensor 34 provides data for automatic windshield wiper operation and may also function as an outdoor light sensor.

The electronic systems center 10 illustrated in FIGS. 1 and 2 also includes heater terminals 38 for providing power to a local heating grid (hidden from view) on the interior of the windshield 18, an interior rearview mirror 40 carried on the housing 12 by attachment to the mirror button or mount 42 and a rearview mirror tether 44 in the form of a hook or other feature that may be integrally formed as a part of the base 14. More specifically, the tether 44 engages a line such as the control line 46 extending from the rearview mirror 40 having an auto dimming feature. Accordingly, in the event a dynamic event leads to detachment of the interior rearview mirror 40 from the mirror button or mount 42, the tether 44 restricts the detached rearview mirror from being propelled across the interior of the motor vehicle.

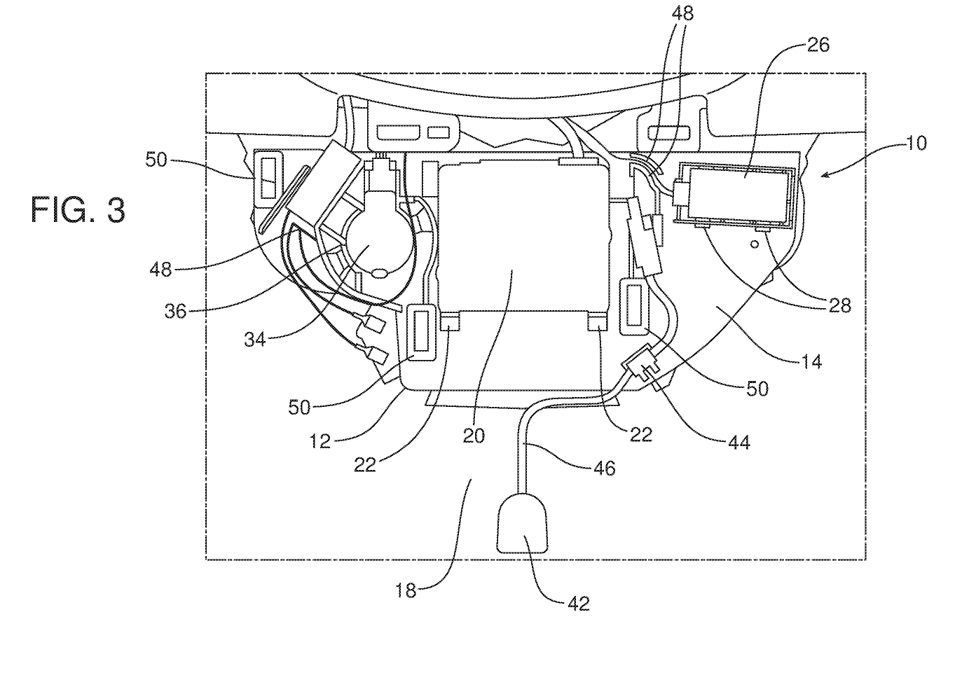

Reference is now made to FIG. 3 illustrating an alternative embodiment of the electronic systems center 10 wherein like features and components are identified by the same reference numbers utilized to identify those components of the electronic systems center 10 embodiment illustrated in FIGS. 1 and 2. Thus, as should be appreciated, the second embodiment of the electronic systems center 10 illustrated in FIG. 3 includes a housing 12 with a base 14 with an integral retainer 22 for holding the image processing module 20, an integral retainer 28 for holding the USB charger 26, an integral retainer 36 for holding the rain sensor 34, a rearview mirror tether 44 and a mirror button or mount 42 that is secured to the windshield 18 at a point remote from the base 14.

In contrast to the electronic systems center 10 illustrated in FIGS. 1 and 2, the electronic system center 10 illustrated in FIG. 3 does not include an EWAFS module 30 or the integral retainer 32 for that module. The second embodiment of the electronic systems center 10 illustrated in FIG. 3 does, however, include various wire routing features 48 which serve to eliminate rattling of wires under the cover (not shown), and cover mounting features in the form of receivers 50 that engage and hold mounting tabs (not shown) on the cooperating cover that closes the housing 12 and conceals the various components within the housing.

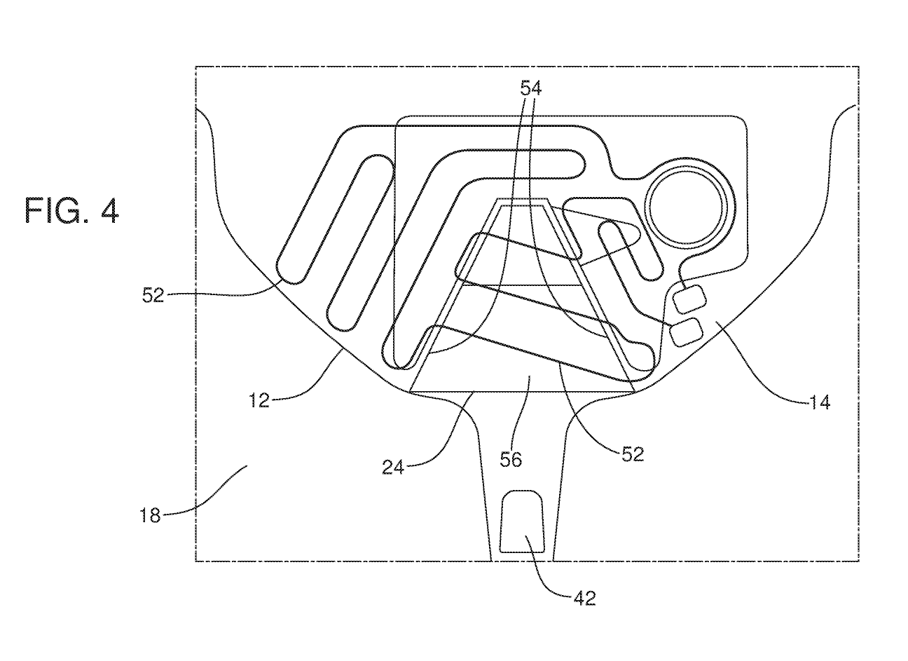

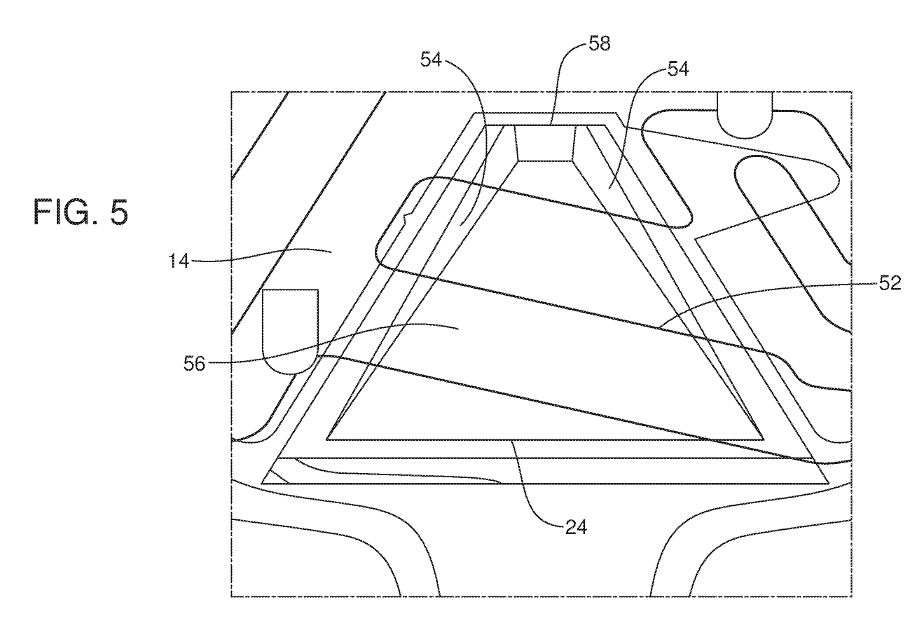

Reference is now made to FIG. 4 illustrating the local heating grid 52 that is provided along the interior face of the windshield 18 overlying the imaging port 24 in the housing 12 of the embodiment of FIGS. 1 and 2 and, more particularly, the base 14 through which the image processing module 20 obtains forward view images. As illustrated, the image port 24 includes diverging sidewalls 54 extending forward from the image processing module 20. The image port 24, including the diverging sidewalls 54, includes a glare shield 56 by means of a molded-in texture that equates to 0.5 to 2.0 gloss using a 60 degree gloss meter. As should be appreciated, such a glare shield 56 is fully integrated into the base 14 so as to reduce cost and complexity. FIG. 5 provides a more detailed view of the imaging port 24 and the integral glare shield 56. Note the diverging sidewalls 54 extending from the image processing module end 58 of the imaging port.

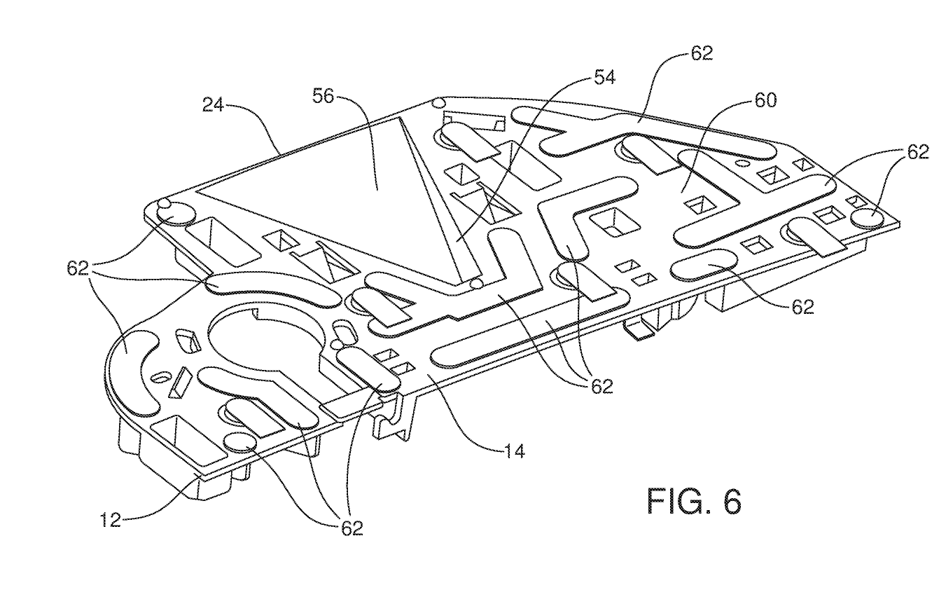

FIG. 6 is a detailed perspective view of the upper or windshield abutting face 60 of the base 14 of the FIG. 3 embodiment. In the illustrated embodiment, the base 14 is secured to the windshield by a fastener 62 in the form of an appropriate adhesive provided at the indicated locations. FIG. 6 also shows the imaging port 24 with the integral glare shield 56.

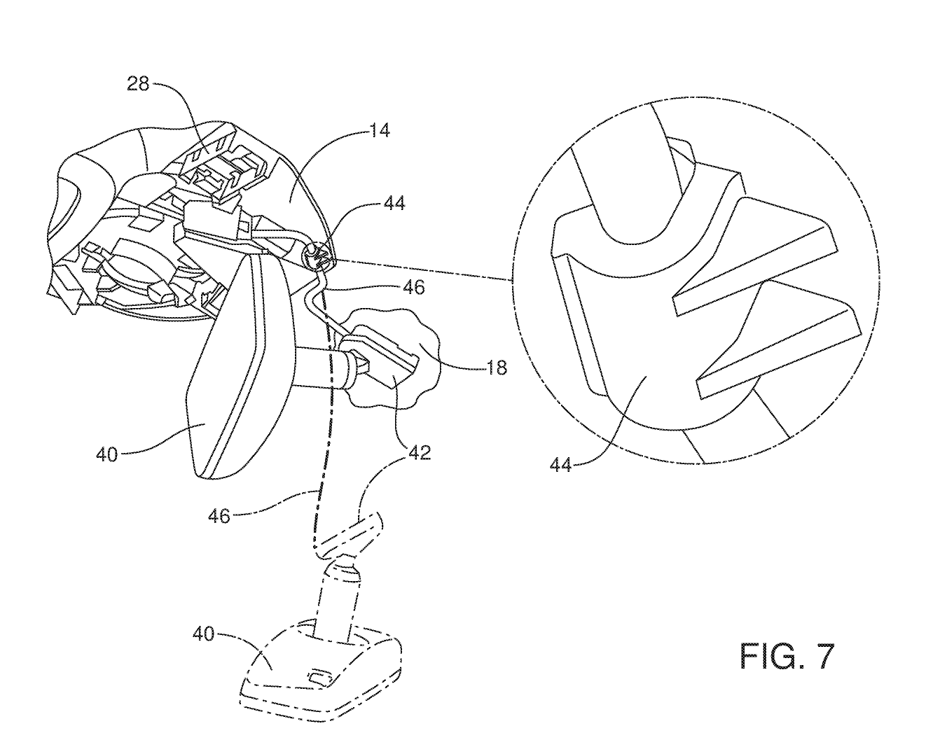

FIG. 7 is a detailed view of the rearview mirror tether 44. In this embodiment, the rearview mirror tether 44 comprises a hook that is integrally formed with the base 14, engaging the line 46 that provides electrical power for the auto dimming interior rearview mirror 40. In the event the rearview mirror 40 becomes detached from the windshield 18 for any reason such as a dynamic crash event, the rearview mirror tether 44 grips the line 46 limiting the free travel of the detached rearview mirror 40 (note phantom line illustration) within the passenger compartment of the motor vehicle.

The foregoing has been presented for purposes of illustration and description. It is not intended to be exhaustive or to limit the embodiments to the precise form disclosed. Obvious modifications and variations are possible in light of the above teachings. For example, the electronic systems center 10 may house only one or more of the following devices within the low profile housing 10. Those devices may be selected from a group consisting of an image processing module 20, a USB charger 26, an EWAFS module 30, a rain sensor 34, a rearview mirror 40, a rearview mirror tether 44, windshield heater terminals 38 and combinations thereof. All such modifications and variations are within the scope of the appended claims when interpreted in accordance with the breadth to which they are fairly, legally and equitably entitled.

1. An electronic systems center, comprising:
a housing including a base and a cover;
an image processing module held in said housing;
an imaging port in said housing; and
an electronic windshield anti-fogging system (EWAFS) module held in said housing.

2. The electronic systems center of claim 1, wherein said imaging port includes diverging sidewalls.

3. The electronic systems center of claim 1, further including a USB charger held in said housing.

4. The electronic systems center of claim 1, further including a rearview mirror tether.

5. The electronic systems center of claim 1, further including a rain sensor held in said housing.

6. The electronic systems center of claim 1, further including a rearview mirror carried on said housing.

7. The electronic systems center of claim 1, further including windshield heater terminals carried on said housing.

8. The electronic systems center of claim 1, further including a rearview mirror and a rearview mirror tether carried on said base.

9. The electronic systems center of claim 8, wherein said base includes an integral retainer holding said image processing module.

10. The electronic systems center of claim 1, further including at least one device selected from a group consisting of a USB charger, a rain sensor, a rearview mirror, a rearview mirror tether, windshield heater terminals and combinations thereof, carried on said housing.

11. The electronic systems center of claim 10, further including a fastener securing said housing to a motor vehicle windshield.

12.-19. (canceled)
